(19) United States
(12) Patent Application Publication
(10) Pub. No.: US 2024/0021181 A1
(43) Pub. Date: Jan. 18, 2024

(54) ELECTRONIC MUSICAL INSTRUMENT, AUTOMATIC OPERATION METHOD, AND NON-TRANSITORY COMPUTER READABLE MEDIUM

(71) Applicant: Roland Corporation, Shizuoka (JP)

(72) Inventor: Ryo Susami, Hamamatsu (JP)

(73) Assignee: Roland Corporation, Shizuoka (JP)

(21) Appl. No.: 18/334,326

(22) Filed: Jun. 13, 2023

(30) Foreign Application Priority Data
Jul. 18, 2022 (JP) 2022-114426

(51) Int. Cl. G10H 1/26

(52) U.S. Cl. CPC G10H 1/26

(57) ABSTRACT

An electronic musical instrument is provided with a keyboard including a key that allows automatic operation. The electronic musical instrument includes: a performance information acquisition part, acquiring performance information containing note-on or note-off and an input timing of the performance information; a key drive timing setting part, setting a key drive timing based on the input timing of the performance information; an advancement part, in response to a time difference between the key drive timing of previous performance information and the key drive timing of subsequent performance information related to the same sound as the previous performance information being less than or equal to a predetermined timing threshold, re-setting the key drive timing of the previous performance information to an advanced timing; and an automatic operation part, performing automatic operation of the key of the keyboard at the key drive timing of the performance information.

### CROSS-REFERENCE TO RELATED APPLICATION

This application claims the priority benefit of Japan Application No. 2022-114426, filed on Jul. 18, 2022. The entirety of the above-mentioned patent application is hereby incorporated by reference herein and made a part of this specification.

### BACKGROUND

### Technical Field

The disclosure relates to an electronic musical instrument, an automatic operation method, and an automatic operation program.

### Related Art

Patent Document 1 (Japanese Patent Laid-Open No. 2008-233825) discloses an electronic musical instrument in which key-on data and key-off data are acquired from song data stored in an external storage device, and, as a musical tone is generated and output by a sound source circuit and a sound system using the acquired key-on data and key-off data, a key is depressed and released by driving of a solenoid. Such outputting of the musical tone and operation of the key can make it appear to a user that the musical tone is being output according to an automatic action (automatic operation) of the key.

In order to realize repeated key striking in a performance, immediately after previous key-off data in the song data, subsequent key-on data based on the same sound may be stored. In this case, the user is able to recognize a “break of sound” caused by the previous key-off data and the subsequent key-on data in the output musical tone. On the other hand, since the key is driven by the solenoid, before the key is sufficiently released by the previous key-off data, key depression may be started by the subsequent key-on data. Accordingly, it may appear to the user that the key is hardly operating, and the user may experience a feeling of incongruity between the key and the output musical tone in which a “break of sound” can be recognized.

Accordingly, in Patent Document 1, in the case where the previous key-off data and the subsequent key-on data based on the same sound are acquired in a short time, the subsequent key-on data delays a timing of depressing the key. Accordingly, the key can be depressed by the subsequent key-on data after the key has been sufficiently released by the previous key-off data.

However, since depression of the key is delayed by the subsequent key-on data, a gap may occur between the output musical tone and the operation of the key, such as that depression of the key may be started after output of the musical tone by the subsequent key-on data is started. There is a problem that such a gap between the output musical tone and the operation of the key may give the user a feeling of incongruity.

### SUMMARY

The disclosure provides an electronic musical instrument, an automatic operation method, and an automatic operation program, in which a gap between an output musical tone and an automatically operated key can be reduced.

An electronic musical instrument according to the disclosure is provided with a keyboard including a key that allows automatic operation. The electronic musical instrument includes: a performance information acquisition part, acquiring performance information containing note-on or note-off and an input timing of the performance information; a key drive timing setting part, setting a key drive timing being a timing of performing automatic operation of the key of the keyboard according to the performance information acquired by the performance information acquisition part based on the input timing of the performance information; an advancement part, in response to a time difference between the key drive timing of previous performance information set by the key drive timing setting part and the key drive timing of subsequent performance information related to the same sound as the previous performance information being less than or equal to a predetermined timing threshold, re-setting the key drive timing of the previous performance information to an advanced timing; and an automatic operation part, performing automatic operation of the key of the keyboard based on the performance information acquired by the performance information acquisition part at the key drive timing of the performance information.

An automatic operation method according to the disclosure is a method executed by an electronic musical instrument provided with a keyboard including a key that allows automatic operation. The automatic operation method includes the following. In a performance information acquisition step, performance information containing note-on or note-off and an input timing of the performance information are acquired. In a key drive timing setting step, a key drive timing being a timing of performing automatic operation of the key of the keyboard according to the performance information acquired in the performance information acquisition step is set based on the input timing of the performance information. In an advancement step, in response to a time difference between the key drive timing of previous performance information set in the key drive timing setting step and the key drive timing of subsequent performance information related to the same sound as the previous performance information being less than or equal to a predetermined timing threshold, the key drive timing of the previous performance information is re-set to an advanced timing. In an automatic operation step, automatic operation of the key of the keyboard is performed based on the performance information acquired in the performance information acquisition step at the key drive timing of the performance information.

An automatic operation program according to the disclosure is a program for causing a computer provided with a keyboard including a key that allows automatic operation to execute automatic operation processing of the key of the keyboard. The automatic operation program causes the computer to execute: a performance information acquisition step of acquiring performance information containing note-on or note-off and an input timing of the performance information; a key drive timing setting step of setting a key drive timing being a timing of performing automatic operation of the key of the keyboard according to the performance information acquired in the performance information acquisition step based on the input timing of the performance information; an advancement step of, in response to a time difference between the key drive timing of previous performance information set in the key drive timing setting step and the key drive timing of subsequent performance information related to the same sound as the previous performance information being less than or equal to a predetermined timing threshold, re-setting the key drive timing of the previous performance information to an advanced timing; and an automatic operation step of performing automatic operation of the key of the keyboard based on the performance information acquired in the performance information acquisition step at the key drive timing of the performance information.

### BRIEF DESCRIPTION OF THE DRAWINGS

FIG. 1 illustrates an appearance of an electronic piano.

FIG. 2A illustrates a timing of automatic operation of a key and output of a musical tone in the related art. FIG. 2B illustrates a timing of automatic operation of a key and output of a musical tone before previous note-off is advanced and subsequent note-on is delayed in an embodiment. FIG. 2C illustrates a timing of automatic operation of a key and output of a musical tone after previous note-off is advanced and subsequent note-on is delayed in an embodiment.

FIG. 3A illustrates a timing of automatic operation of a key and output of a musical tone before subsequent note-off is delayed in an embodiment. FIG. 3B illustrates a timing of automatic operation of a key and output of a musical tone after subsequent note-off is delayed in an embodiment.

FIG. 4 is a functional block diagram of an electronic piano.

FIG. 5A is a block diagram illustrating an electrical configuration of an electronic piano.

FIG. 5B schematically illustrates a sound production note buffer. FIG. 5C schematically illustrates a key drive note buffer.

FIG. 6 is a flowchart of main processing.

FIG. 7 is a flowchart of key drive note addition processing.

FIG. 8 is a flowchart of timer event processing.

FIG. 9A illustrates a timing of automatic operation of a key and output of a musical tone after previous note-off is advanced in a modification. FIG. 9B illustrates a timing of automatic operation of a key and output of a musical tone after previous note-off is advanced in a modification.

FIG. 10 is a flowchart of key drive note addition processing in a modification.

### DESCRIPTION OF THE EMBODIMENTS

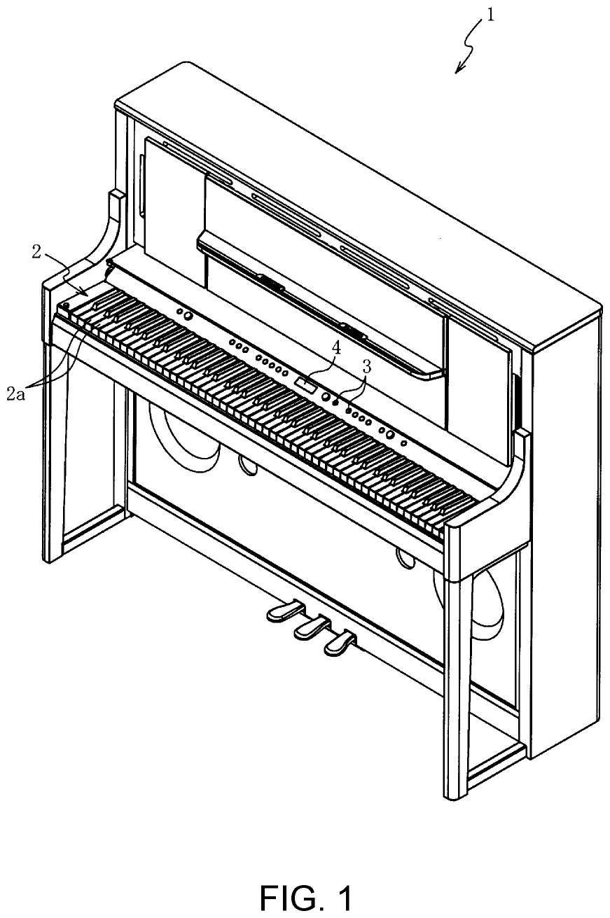

Hereinafter, embodiments will be described with reference to the accompanying drawings. First, an overview of an electronic piano 1 of the present embodiment is described with reference to FIG. 1. FIG. 1 illustrates an appearance of the electronic piano 1. The electronic piano 1 is an electronic musical instrument that produces a musical tone based on a performance of a user H, or a musical tone based on Musical Instrument Digital Interface (MIDI) data MD being music data conforming to the MIDI standard.

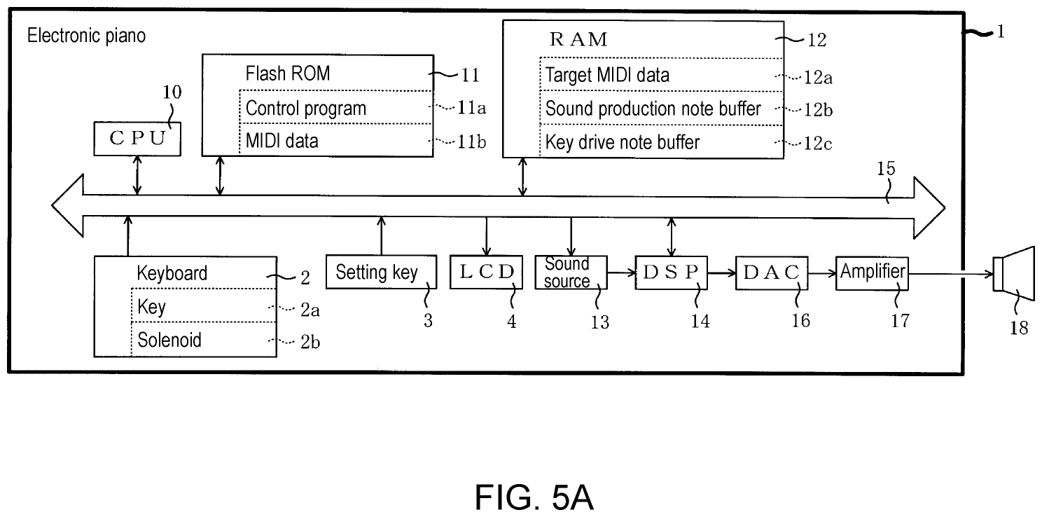

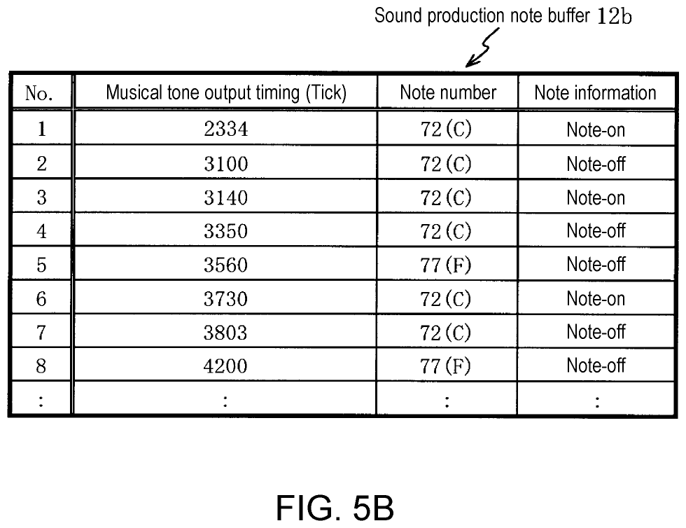

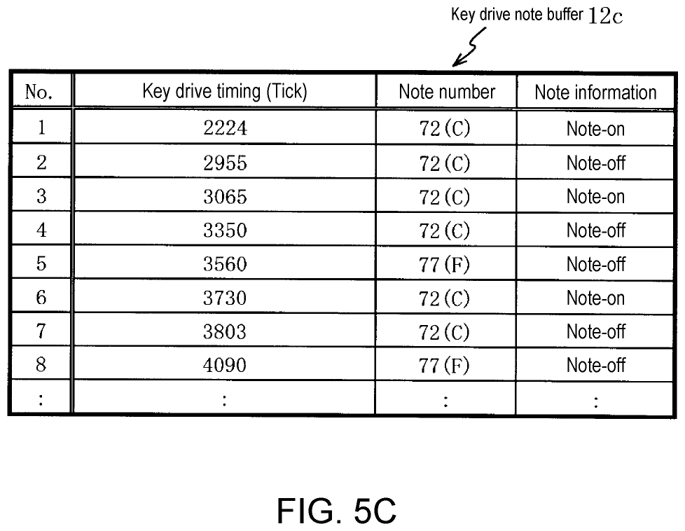

The electronic piano 1 is mainly provided with a keyboard 2, a setting key 3 to which various settings from the user H are input, and an LCD 4 displaying a setting state of the various settings or the like. The keyboard 2 is an input device for acquiring performance information according to the performance of the user H. The keyboard 2 is provided with a plurality of keys 2a. The performance information conforming to the MIDI standard, which corresponds to a key depression/key release operation on the key 2a by the user H, is output to a CPU 10 (see FIG. 5A) and is output as a musical tone.

The keyboard 2 is provided with a solenoid 2b that independently drives each key 2a up and down. When note-on in the performance information is acquired from the MIDI data MD specified by the user H, by driving the key 2a downward by the solenoid 2b, depression of the key 2a is realized. On the other hand, when note-off in the performance information is acquired from the MIDI data MD, by driving the key 2a upward by the solenoid 2b, release of the key 2a is realized.

By synchronizing the depression/release of the key 2a by the solenoid 2b based on the MIDI data MD specified by the user H with production of a musical tone according to the MIDI data MD, it is possible to make it appear to the user H that the electronic piano 1 is automatically playing. Hereinafter, such an act of driving the solenoid 2b based on the MIDI data MD to operate the key 2a is referred to as “automatic operation of the key 2a”.

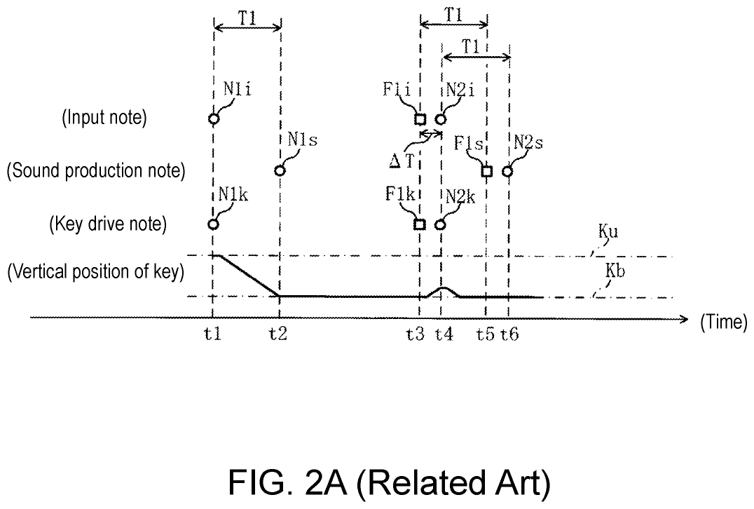

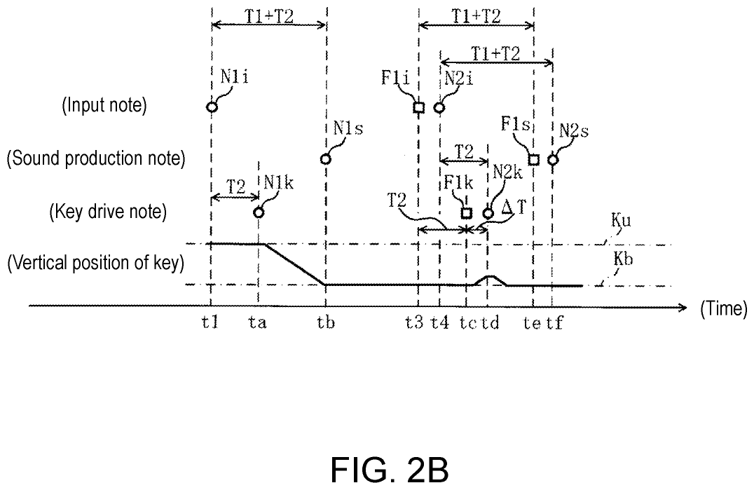

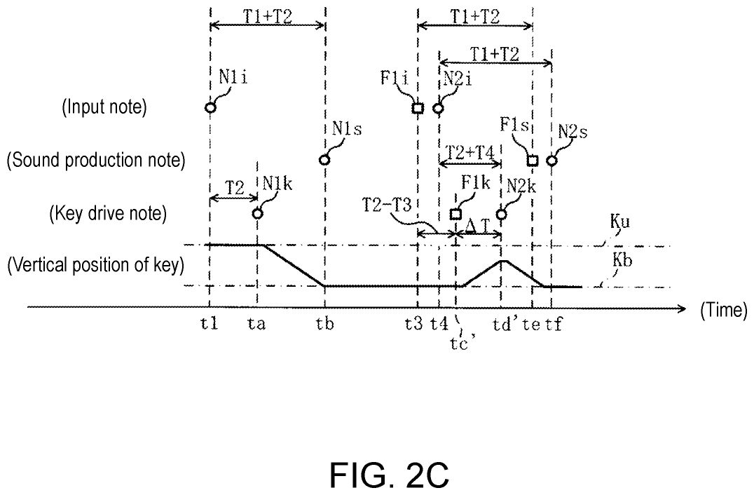

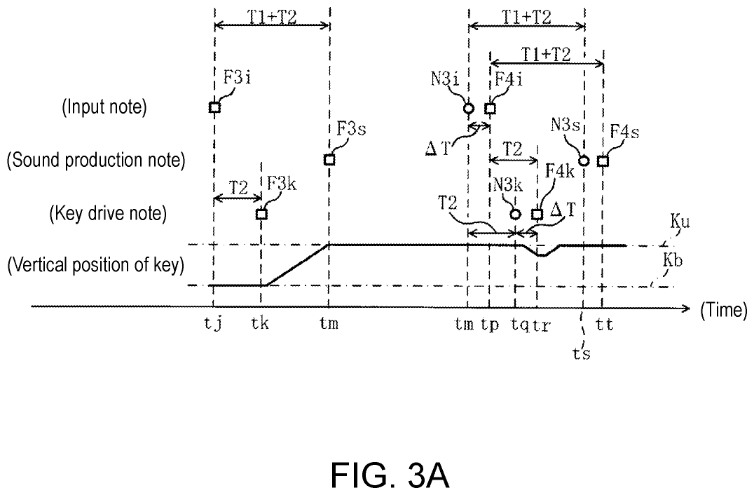

In the present embodiment, in the case of a small time difference between timings of acquiring previous note-off and acquiring subsequent note-on related to the same sound, by advancing a timing of automatic operation of the key 2a by the previous note-off and further delaying a timing of automatic operation of the key 2a by the subsequent note-on, the release of the key 2a by the previous note-off can be sufficiently executed. The timing of automatic operation of the key 2a is described with reference to FIG. 2A to FIG. 2C and FIG. 3A to FIG. 3B.

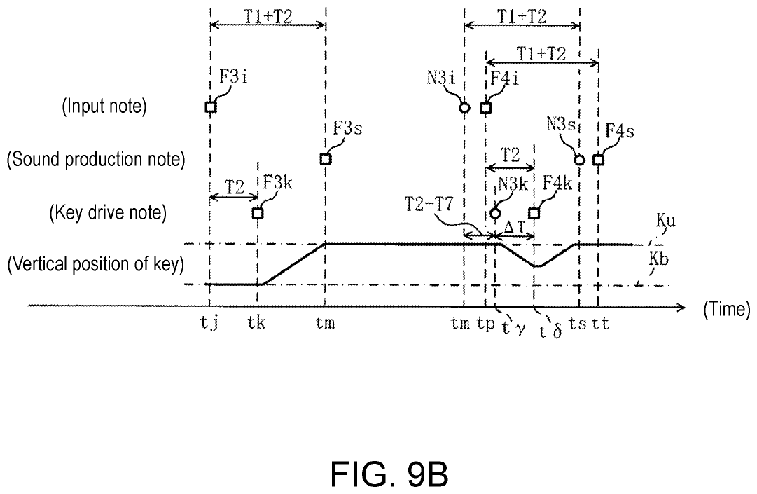

FIG. 2A illustrates a timing of automatic operation of the key 2a in the related art. In FIG. 2A to FIG. 2C and subsequent FIG. 3A to FIG. 3B and FIG. 9A to FIG. 9B, the horizontal axis serves as a time axis. In the present embodiment, “tick” is used as a unit of time, and the time required per tick is exemplified by “1 millisecond”. The unit of time is not limited to “tick”, and other units of time such as “second” or “minute” may be used. The time required per tick is not limited to 1 millisecond, and may be 1 millisecond or more or 1 millisecond or less.

The performance information acquired from the MIDI data MD is referred to as an “input note”, and “i” is attached to the end of a sign thereof. An input note arranged at a timing of producing a musical tone is referred to as a “sound production note”, and “s” is attached to the end of a sign thereof. An input note arranged at a timing of automatic operation of the key 2a is referred to as a “key drive note”, and “k” is attached to the end of a sign thereof. In the input note, sound production note and key drive note, note-on is represented by a circle (“o”), and note-off is represented by a white square (“Q”).

A vertical position of the key 2a when the key 2a is automatically operated by the key drive note is defined as a “vertical position of the key”, in which the vertical position of the key 2a in the case where the key 2a is completely released is defined as a “key release position Ku”, and the vertical position of the key 2a in the case where the key 2a is completely depressed is defined as a “key depression position Kb”.

Conventionally, as illustrated in FIG. 2A, in the case where an input note is acquired from the MIDI data MD, a key drive note and a sound production note are arranged based on a timing corresponding to the input note. At the timing (hereinafter referred to as “key drive timing”) of the arranged key drive note, automatic operation of the key 2a is performed; at the timing (hereinafter referred to as “musical tone output timing”) of the arranged sound production note, a musical tone is output.

Conventionally, the key drive timing is set to substantially the same timing as an input timing of the input note. On the other hand, the musical tone output timing is set to a timing delayed from the input timing of the input note by a key drive delay time T1. Here, the key drive delay time T1 is a time based on the time required for the key 2a that has been completely released to be completely depressed by the solenoid 2b, and the key drive delay time T1 is exemplified by “110 milliseconds”.

For example, in the case where note-on N1i as an input note is acquired at time t1, note-on Nik as a key drive note corresponding to the input note is arranged at time t1, and note-on Nis as a sound production note corresponding to the input note is arranged at time t2 after the key drive delay time T1 from time t1. By arranging note-on N1s and note-on N1k at timings separated by the key drive delay time T1 in this way, a time lag between the output musical tone and the automatic operation of the key 2a can be reduced.

In order to realize repeated key striking in a performance, a time difference between a timing at which the previous note-off is acquired from the MIDI data MD and a timing at which the subsequent note-on related to the same sound as the previous note-off is acquired from the MIDI data MD may be small. For example, like note-off F1i and note-on N2i as input notes in FIG. 2A, a time difference ΔT between them may be acquired in a short time.

In such a case, if note-off F1k and note-on N2k are used for automatic operation of the key 2a while the time difference ΔT is maintained, it is necessary to physically move the key 2a by the solenoid 2b. Thus, before the key 2a is sufficiently released by the previous note-off F1k, depression of the key 2a may be started by the subsequent note-on N2k. Accordingly, it may appear to the user H that the key 2a is hardly operating.

On the other hand, output of a musical tone by note-off F1s and note-on N2s is executed even if the time difference ΔT between note-off F1s and note-on N2s is a short time, and the user H is able to distinguish the musical tone output. That is, for the user H, although the key 2a hardly operates, the musical tone by note-off F1s and note-on N2s is recognized as being output. Thus, a feeling of incongruity may be experienced between automatic operation of the key 2a and output of the musical tone.

Accordingly, in the present embodiment, in the case where the time difference ΔT between the previous note-off and the subsequent note-on based on the same sound in the key drive note is less than a predetermined time, by advancing a timing of the previous note-off and delaying the subsequent note-on, release of the key 2a by the previous note-off is sufficiently realized. Advancement of the previous note-off and delay of the subsequent note-on in the present embodiment are described with reference to FIG. 2B and FIG. 2C.

FIG. 2B illustrates a timing of automatic operation of a key and output of a musical tone before previous note-off is advanced and subsequent note-on is delayed in the present embodiment. In the present embodiment, in the case where an input note is acquired, a musical tone output timing and a key drive timing corresponding to the input note are delayed.

Specifically, the musical tone output timing is a timing delayed from an input timing of the corresponding input note by a time obtained by adding the key drive delay time T1 and a lookahead delay time T2, and the key drive timing is a timing delayed from the input timing of the corresponding input note by the lookahead delay time T2. The lookahead delay time T2 is a time based on a later-described note-off advance time T3 by which the previous note-off is advanced and a later-described note-on delay time T4 by which the subsequent note-on is delayed, and the lookahead delay time T2 is exemplified by “75 milliseconds”.

In a key drive note delayed from an input timing of an input note by the lookahead delay time T2, if the time difference ΔT between the previous note-off and the subsequent note-on is small, for example, if the time difference ΔT between the previous note-off F1k and the subsequent note-on N2k in FIG. 2B is less than a time obtained by adding the note-off advance time T3 and the note-on delay time T4, the previous note-off F1k is advanced by the note-off advance time T3, and note-on N2k is delayed by the note-on delay time T4.

In the present embodiment, the note-off advance time T3 and the note-on delay time T4 are each exemplified by “35 milliseconds”. That is, the lookahead delay time T2, the note-off advance time T3 and the note-on delay time T4 are set so that the time obtained by adding the note-off advance time T3 and the note-on delay time T4 is less than or equal to the lookahead delay time T2.

A key drive timing of the previous note-off F1k that is advanced is set to a time delayed from an input timing of the corresponding note-off F1i by the lookahead delay time T2 and further advanced from that time by the note-off advance time T3. That is, the key drive timing of the previous note-off F1k is set to a time delayed from the input timing of note-off F1i by a time obtained by subtracting the note-off advance time T3 from the lookahead delay time T2.

On the other hand, a key drive timing of the subsequent note-on N2k that is delayed is set to a time delayed from an input timing (time t4) of the corresponding note-on N2i by the lookahead delay time T2 and further by the note-on delay time T4. That is, the key drive timing of the subsequent note-on N2k is set to a time delayed from the input timing of note-on N2i by a time obtained by adding the lookahead delay time T2 and the note-on delay time T4.

By advancing the key drive timing of the previous note-off F1k and delaying the key drive timing of the subsequent note-on N2k in this way, it is possible to secure a time from the start of release of the key 2a by the previous note-off F1k to the start of depression of the key 2a by the subsequent note-on N2k. Thus, depression of the key 2a by the subsequent note-on N2k can be performed after the key 2a has been sufficiently released by the previous note-off F1k. Accordingly, since a gap between the automatic operation of the key 2a by note-off F1k and note-on N2k and the output of the musical tone by note-off F1s and note-on N2s is reduced, the feeling of incongruity experienced by the user H due to the automatic operation of the key 2a and the output of the musical tone can be reduced.

In securing the time between the key drive timing of the previous note-off F1k and the key drive timing of the subsequent note-on N2k, by changing each of the key drive timing of the previous note-off F1k and the key drive timing of the subsequent note-on N2k, a large gap between either of the key drive timing of the previous note-off F1k and the key drive timing of the subsequent note-on N2k and either the musical tone output timing of the previous note-off F1s or the musical tone output timing of the subsequent note-on N2s corresponding thereto can be reduced.

The note-off advance time T3 and the note-on delay time T4 are each set to 35 milliseconds. However, the disclosure is not limited thereto. If the time obtained by adding the note-off advance time T3 and the note-on delay time T4 is less than or equal to the lookahead delay time T2, the note-off advance time T3 and the note-on delay time T4 may be 35 milliseconds or more or 35 milliseconds or less. The longer the time obtained by adding the note-off advance time T3 and the note-on delay time T4, the more possible it is to realize a “full stroke” in which the key 2a of the keyboard 2 is depressed from a completely released state. On the other hand, the shorter the time obtained by adding the note-off advance time T3 and the note-on delay time T4, the more possible it is to realize an operation similar to the actual repeated striking of the key 2a, in which the key 2a is released halfway and then depressed.

Next, with reference to FIG. 3A to FIG. 3B, a case is described where the time difference ΔT between the previous note-on and the subsequent note-off based on the same sound in a key drive note is small. FIG. 3A illustrates a timing of automatic operation of a key and output of a musical tone before subsequent note-off is delayed in the present embodiment. In FIG. 3A, even if the time difference ΔT between a key drive timing of the previous note-on N3k and a key drive timing of the subsequent note-off F4k based on the same sound is small, before the key 2a is sufficiently depressed by the previous note-on N3k, release of the key 2a is started by the subsequent note-off F4k. Accordingly, it may appear to the user H that the key 2a is hardly operating.

Accordingly, in the present embodiment, in the case where the time difference ΔT between the key drive timing of the previous note-on N3k and the key drive timing of the subsequent note-off F4k based on the same sound is small, by delaying the key drive timing of the subsequent note-off F4k, a time for depressing the key 2a by the previous note-on N3k is secured. Delay of the key drive timing of the subsequent note-off F4k is described with reference to FIG. 3B.

FIG. 3B illustrates a timing of automatic operation of a key and output of a musical tone after subsequent note-off is delayed in the present embodiment. In the case where the time difference ΔT between the key drive timing of the previous note-on N3k and the key drive timing of the subsequent note-off F4k is less than a note-off delay time T5, the key drive timing of the subsequent note-off F4k is delayed by the note-off delay time T5.

Specifically, the key drive timing of the subsequent note-off F4k is set to a time delayed from an input timing (time tp) of the corresponding note-off F4i by a time obtained by adding the lookahead delay time T2 and the note-off delay time T5. While the note-off delay time T5 is exemplified by “110 milliseconds” in the present embodiment, the note-off delay time T5 may be 110 milliseconds or more or 110 milliseconds or less.

By delaying the key drive timing of the subsequent note-off F4k in this way, a time from the start of depression of the key 2a by the previous note-on N3k to the start of release of the key 2a by the subsequent note-off F4k can be secured. Thus, the key 2a can be released after it has been sufficiently depressed. Accordingly, since a gap between the automatic operation of the key 2a by note-on N3k and note-off F4k and the output of the musical tone by note-on N3s and note-off F4s is reduced, the feeling of incongruity experienced by the user H due to the automatic operation of the key 2a and the output of the musical tone can be reduced.

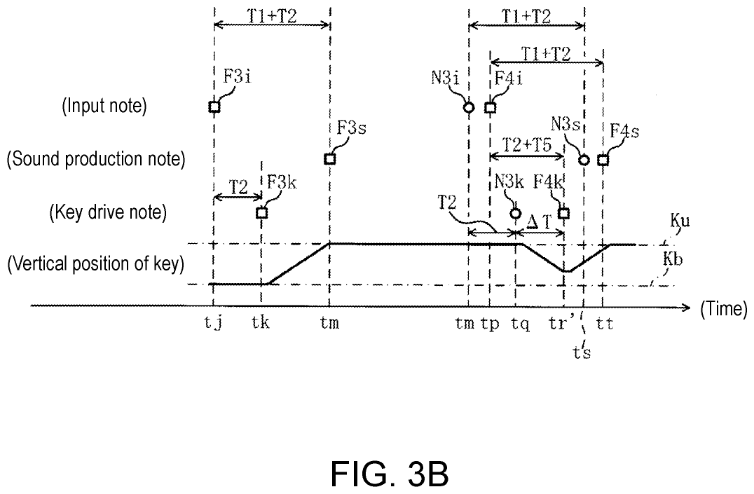

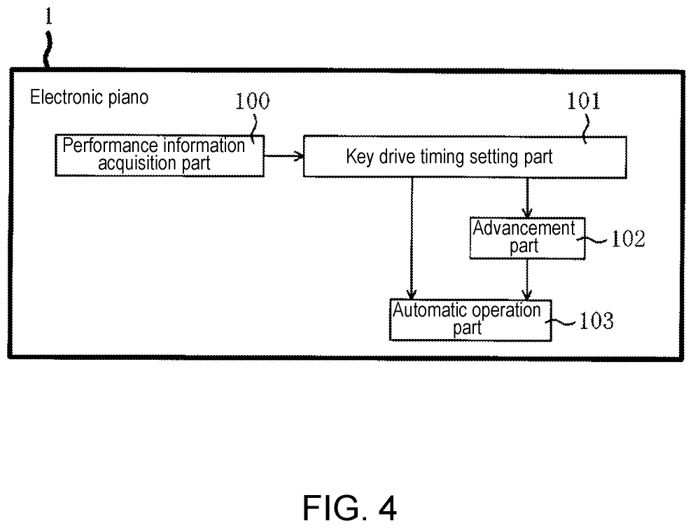

Next, a function of the electronic piano 1 is described with reference to FIG. 4. FIG. 4 is a functional block diagram of the electronic piano 1. As illustrated in FIG. 4, the electronic piano 1 includes a performance information acquisition part 100, a key drive timing setting part 101, an advancement part 102, and an automatic operation part 103.

The performance information acquisition part 100 is a means of acquiring performance information and an input timing of the performance information, and is realized by the CPU 10 described later in FIG. 5A. The key drive timing setting part 101 is a means of setting a key drive timing based on the input timing of the performance information, the key drive timing being a timing of performing automatic operation of the key 2a of the keyboard 2 according to the performance information acquired by the performance information acquisition part 100. The key drive timing setting part 101 is realized by the CPU 10.

The advancement part 102 is a means of re-setting a key drive timing of previous performance information set by the key drive timing setting part 101 to an advanced timing in the case where a time difference between the key drive timing of the previous performance information and a key drive timing of subsequent performance information related to the same sound as the previous performance information is less than or equal to a predetermined timing threshold. The advancement part 102 is realized by the CPU 10. The automatic operation part 103 is a means of automatically operating the key 2a of the keyboard 2 based on the performance information acquired by the performance information acquisition part 100 at the key drive timing of the performance information. The automatic operation part 103 is realized by the CPU 10 and the solenoid 2b.

In the case where the time difference between the key drive timing of the previous performance information and the key drive timing of the subsequent performance information is less than or equal to the predetermined timing threshold, the key drive timing of the key 2a according to the previous performance information is re-set to the advanced timing. Accordingly, since a time from the start of the automatic operation of the key 2a according to the previous performance information to the start of the automatic operation of the key 2a according to the subsequent performance information can be made longer than the original time between an input timing of the previous performance information and an input timing of the subsequent performance information, a time for automatically operating the key 2a by the previous performance information can be secured.

In addition, since the key drive timing of the subsequent performance information can be kept as a timing based on the original input timing of the subsequent performance information acquired, a gap between an output timing of a musical tone according to the subsequent performance information and the automatic operation of the key 2a according to the subsequent performance information can be reduced. Accordingly, the user's feeling of incongruity due to the musical tone output by the subsequent performance information and the automatic operation of the key 2a of the keyboard 2 can be reduced.

Next, an electrical configuration of the electronic piano 1 is described with reference to FIG. 5A to FIG. 5C. FIG. 5A is a block diagram illustrating an electrical configuration of the electronic piano 1. The electronic piano 1 includes the CPU 10, a flash ROM 11, a RAM 12, the above-mentioned keyboard 2, setting key 3 and LCD 4, a sound source 13, and a digital signal processor 14 (hereinafter referred to as “DSP 14”), each of which is connected via a bus line 15.

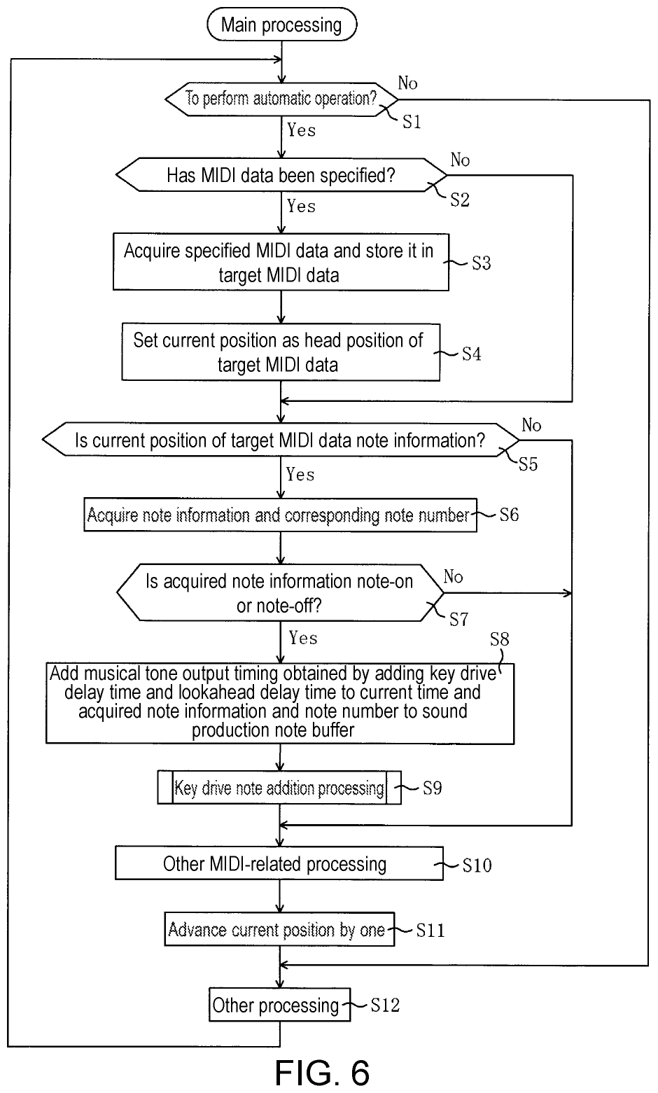

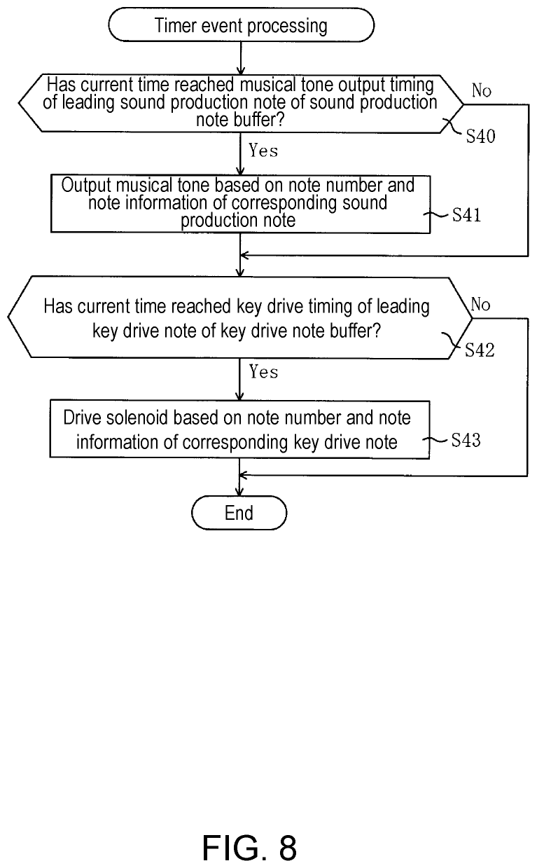

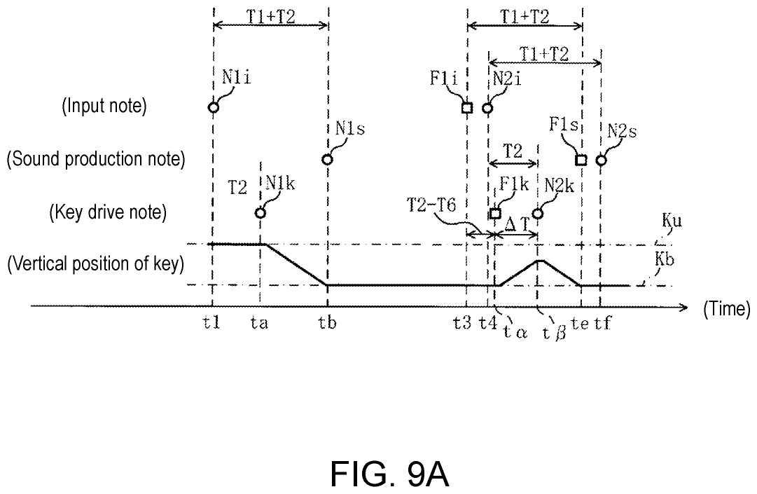

The CPU 10 is an arithmetic unit that controls each part connected by the bus line 15. The flash ROM 11 is a rewritable non-volatile storage device storing programs executed by the CPU 10 or fixed value data or the like, and the flash ROM 11 includes a control program 11a, and MIDI data 11b in which a plurality of MIDI data MD is stored. When the control program 11a is executed by the CPU 10, main processing of FIG. 6 or timer event processing of FIG. 8 is executed.

The RAM 12 is a memory for rewritably storing various work data or flags or the like when the CPU 10 executes a program, and the RAM 12 includes target MIDI data 12a, a sound production note buffer 12b, and a key drive note buffer 12c. The target MIDI data 12a stores the MIDI data MD of a target for the automatic operation of the key 2a or the output of musical tones. The sound production note buffer 12b stores information related to the above sound production note. The key drive note buffer 12c stores information related to the above key drive note. The sound production note buffer 12b and the key drive note buffer 12c are described with reference to FIG. 5B and FIG. 5C.

FIG. 5B schematically illustrates the sound production note buffer 12b. The sound production note buffer 12b stores a musical tone output timing, a note number, and note information in association with each sound production note mentioned above. An example is illustrated in which the sound production note buffer 12b of FIG. 5B stores information related to a sound production note for one timbre such as piano. In the case where the MIDI data MD contains a plurality of timbres, the sound production note buffer 12b may be provided for each timbre, or a single sound production note buffer 12b may store mixed information related to sound production notes of a plurality of timbres. In the case where a single sound production note buffer 12b stores the information related to sound production notes of a plurality of timbres, for example, for each sound production note of the sound production note buffer 12b, the information on the corresponding timbre may be stored.

FIG. 5C schematically illustrates the key drive note buffer 12c. The key drive note buffer 12c stores a key drive timing, a note number, and note information in association with each key drive note mentioned above. An example is illustrated in which the key drive note buffer 12c of FIG. 5C stores information related to a key drive note for one timbre such as piano. However, like the sound production note buffer 12b, in the case where the MIDI data MD contains a plurality of timbres, the key drive note buffer 12c may be provided for each timbre, or a single key drive note buffer 12c may store mixed information related to key drive notes of a plurality of timbres.

Please refer back to FIG. 5A. The sound source 13 is a device that outputs waveform data based on input performance information. The DSP 14 is an arithmetic unit for arithmetically processing the waveform data input from the sound source 13. A digital-to-analog converter (DAC) 16 is connected to the DSP 14, an amplifier 17 is connected to the DAC 16, and a speaker 18 is connected to the amplifier 17.

Next, processing executed by the CPU 10 of the electronic piano 1 is described with reference to FIG. 6 to FIG. 8. FIG. 6 is a flowchart of the main processing. The main processing is the processing executed in the case where the electronic piano 1 is powered on. In the main processing, first, it is confirmed whether to perform the automatic operation of the key 2a (S1). In the present embodiment, whether or not to perform the automatic operation of the key 2a can be set by an operation of the user H on the setting key 3 (see FIG. 1), and a setting state thereof is confirmed in the processing of S1.

In the processing of S1, if the automatic operation of the key 2a is to be performed (S1: Yes), it is confirmed whether one piece of the MIDI data MD stored in the MIDI data 11b has been specified by an operation of the user H on the setting key 3 (S2).

In the processing of S2, if the MIDI data MD has been specified (S2: Yes), the specified MIDI data MD is acquired from the MIDI data 11b and stored in the target MIDI data 12a (S3). After the processing of S3, a current position being a reading position of the MIDI data MD stored in the target MIDI data 12a is set as a head position of the MIDI data MD (S4). On the other hand, in the processing of S2, if the MIDI data MD has not been specified (S2: No), the processing of S3 and S4 is skipped.

After the processing of S2 and S4, it is confirmed whether the current position of the target MIDI data 12a is note information (S5). In the processing of S5, if the current position of the target MIDI data 12a is note information (S5: Yes), a note number corresponding to the note information is acquired (S6). After the processing of S6, it is confirmed whether the note information of the current position of the target MIDI data 12a is note-on or note-off (S7).

In the processing of S7, if the note information is note-on or note-off (S7: Yes), a musical tone output timing obtained by adding the key drive delay time T1 and the lookahead delay time T2 to a current time, the note information of the current position of the target MIDI data 12a and the note number acquired in the processing of S6 are added to the sound production note buffer 12b (S8). A sound production note added to the sound production note buffer 12b by the processing of S8 is used for outputting a musical tone in the timer event processing described later in FIG. 8.

In the present embodiment, the note information of the current position of the target MIDI data 12a corresponds to the input note mentioned above, and the current time at which the input note is acquired from the target MIDI data 12a corresponds to the input timing. In the present embodiment, the current time is acquired by a real-time clock (not illustrated). However, the current time may be acquired from a device other than the real-time clock.

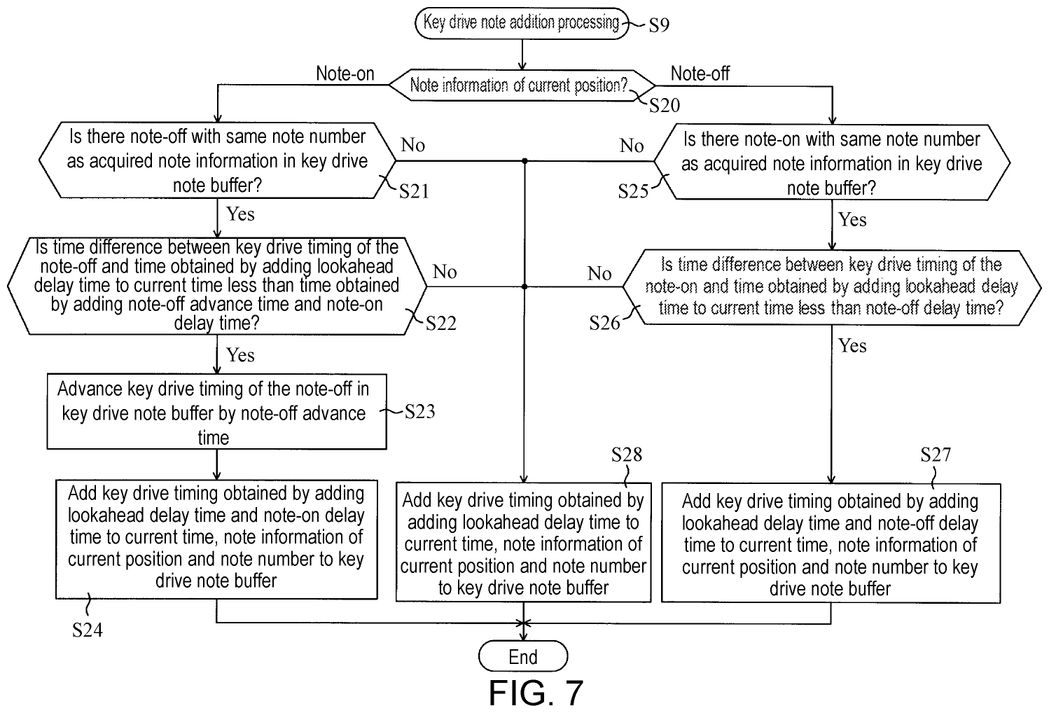

After the processing of S8, key drive note addition processing (S9) is executed. Here, the key drive note addition processing is described with reference to FIG. 7.

FIG. 7 is a flowchart of the key drive note addition processing. In the key drive note addition processing, first, the note information of the current position of the target MIDI data 12a is confirmed (S20). In the processing of S20, if the note information of the current position of the target MIDI data 12a is note-on (S20: “note-on”), it is confirmed whether there is a key drive note of note-off with the same note number as that acquired in the processing of S6 in the key drive note buffer 12c (S21).

In the processing of S21, if there is a key drive note of note-off with the same note number as that acquired in the processing of S6 in the key drive note buffer 12c (S21: Yes), it is confirmed whether the time difference ΔT between the key drive timing of the note-off stored in the key drive note buffer 12c and a time obtained by adding the lookahead delay time T2 to the current time is less than the time obtained by adding the note-off advance time T3 and the note-on delay time T4 (S22).

In the processing of S22, if the time difference ΔT is less than the time obtained by adding the note-off advance time T3 and the note-on delay time T4 (S22: Yes), like note-off F1k and note-on N2k mentioned above in FIG. 2A to FIG. 2C, the time difference ΔT between the note-on of the current position of the target MIDI data 12a and the note-off with the same note number stored in the key drive note buffer 12c may be small, the key drive timing of the note-off may be advanced, and note-on of the current position of the target MIDI data 12a may be delayed.

In such a case, the key drive timing of the note-off stored in the key drive note buffer 12c is advanced by the note-off advance time T3 (S23), and a key drive timing at a time obtained by adding the lookahead delay time T2 and the note-on delay time T4 to the current time, the note information (that is, note-on) of the current position of the target MIDI data 12a and the note number acquired in the processing of S6 are added to the key drive note buffer 12c (S24).

On the other hand, in the processing of S20, if the note information of the current position of the target MIDI data 12a is note-off (S20: “note-off”), it is confirmed whether there is a key drive note of note-on with the same note number as that acquired in the processing of S6 in the key drive note buffer 12c (S25).

In the processing of S25, if there is a key drive note of note-on with the same note number as that acquired in the processing of S6 in the key drive note buffer 12c (S25: Yes), it is confirmed whether the time difference ΔT between the key drive timing of the note-on stored in the key drive note buffer 12c and the time obtained by adding the lookahead delay time T2 to the current time is less than the note-off delay time T5 (S26).

In the processing of S26, if the time difference ΔT is less than the note-off delay time T5 (S26: Yes), like note-on N3k and note-off F4k mentioned above in FIG. 3A to FIG. 3B, the time difference ΔT between the note-off of the current position of the target MIDI data 12a and the note-on with the same note number stored in the key drive note buffer 12c may be small, and the note-on of the current position of the target MIDI data 12a may be delayed.

In such a case, a key drive timing at a time obtained by adding the lookahead delay time T2 and the note-off delay time T5 to the current time, the note information (that is, note-off) of the current position of the target MIDI data 12a and the note number acquired in the processing of S6 are add to the key drive note buffer 12c (S27).

In the processing of S21, if there is no key drive note of note-off with the same note number as that acquired in the processing of S6 in the key drive note buffer 12c (S21: No), or in the processing of S22, if the time difference ΔT is equal to or greater than the time obtained by adding the note-off advance time T3 and the note-on delay time T4 (S22: No), or in the processing of S25, if there is no key drive note of note-on with the same note number as that acquired in the processing of S6 in the key drive note buffer 12c (S25: No), or in the processing of S26, if the time difference ΔT is equal to or greater than the note-off delay time T5 (S26: No), a key drive timing at the time obtained by adding the lookahead delay time T2 to the current time, the note information of the current position of the target MIDI data 12a and the note number acquired in the processing of S6 are add to the key drive note buffer 12c (S28). A sound production note added to the key drive note buffer 12c by the processing of S24, S27, or S28 is used for automatic operation of the key 2a by the solenoid 2b in the timer event processing described later in FIG. 8.

After the processing of S24, S27, and S28, the key drive note addition processing is ended.

Please refer back to FIG. 6. In the processing of S5, if the current position of the target MIDI data 12a is not note information (S5: No), or after the key drive note addition processing of S9, other processing related to the MIDI data MD of the target MIDI data 12a is performed (S10), and the current position is advanced by one (S11). Examples of the processing performed in S10 include change of the volume of a musical tone to be output according to a volume change instruction contained in the MIDI data MD, or change of the timbre of a musical tone to be output according to a timbre change instruction contained in the MIDI data MD.

In the processing of S1, if the automatic operation of the key 2a is not to be performed (S1: No), or after the processing of S11, other processing of the electronic piano 1 is executed (S12), and the processing from S1 onward is repeated. Examples of the processing performed in S14 include output of a musical tone based on the performance of the key 2a by the user H.

Next, the timer event processing is described. The timer event processing is timer interrupt processing executed every millisecond separately from the main processing mentioned above. The timer event processing is described with reference to FIG. 8.

FIG. 8 is a flowchart of the timer event processing. In the timer event processing, first, it is confirmed whether the current time has reached a musical tone output timing of a leading sound production note of the sound production note buffer 12b (S40). In the processing of S40, if the current time has reached the musical tone output timing of the leading sound production note of the sound production note buffer 12b (S40: Yes), a musical tone based on the note number and note information of the corresponding sound production note is output (S41). After the musical tone is output by the processing of S41, the musical tone output timing, note number and note information of the corresponding sound production note are deleted from the sound production note buffer 12b.

In the processing of S40, if the current time has not reached the musical tone output timing of the leading sound production note of the sound production note buffer 12b (S40: No), the processing of S41 is skipped.

After the processing of S40 and S41, it is confirmed whether the current time has reached a key drive timing of a leading key drive note of the key drive note buffer 12c (S42). In the processing of S42, if the current time has reached the key drive timing of the leading key drive note of the key drive note buffer 12c (S42: Yes), based on the note number and note information of the corresponding key drive note, the solenoid 2b is driven to perform automatic operation of the key 2a (S43). After the automatic operation of the key 2a is performed by the processing of S43, the key drive timing, note number and note information of the corresponding key drive note are deleted from the key drive note buffer 12c.

In the processing of S42, if the current time has not reached the key drive timing of the leading key drive note of the key drive note buffer 12c (S42: No), or after the processing of S43, the timer event processing is ended.

The time interval at which the timer event processing is executed is not limited to 1 millisecond, and may be 1 millisecond or less or 1 millisecond or more. The musical tone output processing by S40 and S41 and the automatic operation of the key 2a by S40 and S41 are performed in the same timer interrupt processing. However, the disclosure is not limited thereto. The processing of S40 and S41 and the processing of S41 and S42 may be performed respectively in separate timer interrupt processings, or the processing of S40 to S42 may be performed in the main processing mentioned above.

Although the disclosure has been described based on the above embodiments, it can be easily inferred that various improvements or modifications may be made.

In the above embodiment, in the processing of S21 to S24 of FIG. 7, in the case where the time difference ΔT between the key drive timing of the previous note-off of the key drive note and the key drive timing of the subsequent note-on based on the same sound is small, the key drive timing of the previous note-off is advanced, and the key drive timing of the subsequent note-on is delayed. In the processing of S25 to S27 of FIG. 7, in the case where the time difference ΔT between the key drive timing of the previous note-on of the key drive note and the key drive timing of the subsequent note-off based on the same sound is small, the key drive timing of the subsequent note-off is delayed. However, the processing in the case where the time difference ΔT is small is not limited to the above.

For example, as in FIG. 9A, in the case where the time difference ΔT between a key drive timing of the previous note-off F1k and a key drive timing of the subsequent note-on N2k is small, it is possible to only advance the key drive timing of the previous note-off F1k by a second note-off advance time T6. As in FIG. 9B, in the case where the time difference ΔT between a key drive timing of the previous note-on N3k and a key drive timing of the subsequent note-off F4k is small, it is possible to only advance the key drive timing of the previous note-on N3k by a note-on advance time T7. Here, the second note-off advance time T6 and the note-on advance time T7 are set shorter than the lookahead delay time T2, and are each exemplified by “35 milliseconds”. However, the second note-off advance time T6 and the note-on advance time T7 may be 35 milliseconds or more or 35 milliseconds or less.

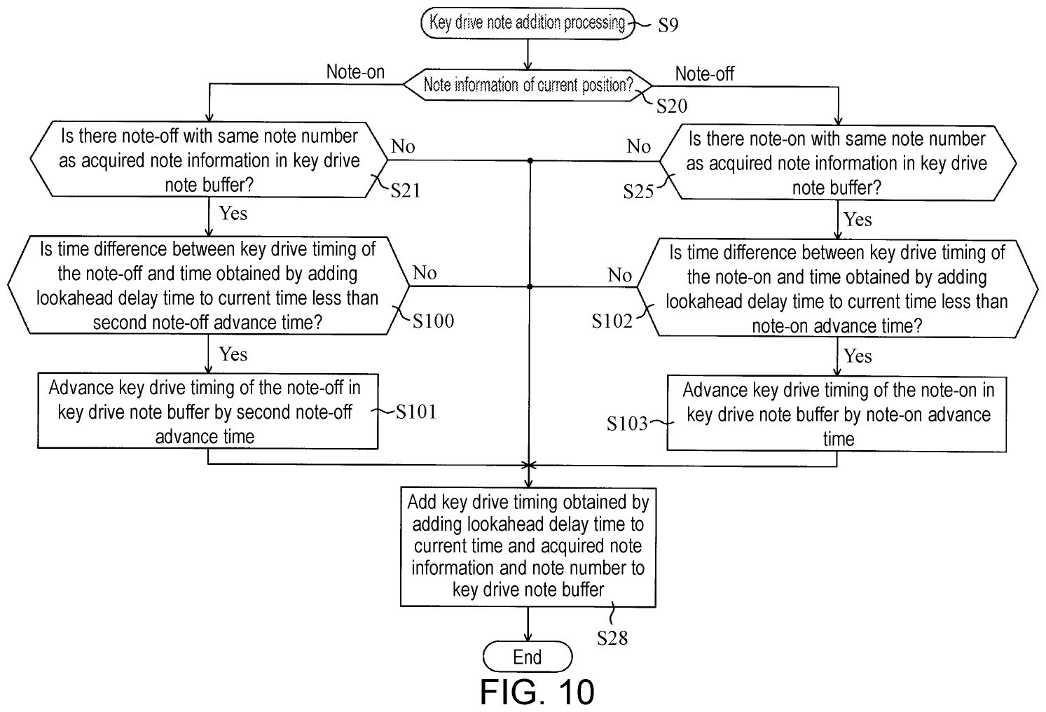

In this case, as in the key drive note addition processing in a modification of FIG. 10, in the processing of S21, if there is a key drive note of note-off with the same note number as that acquired in the processing of S6 in the key drive note buffer 12c (S21: Yes), it is confirmed whether the time difference ΔT between the key drive timing of the note-off stored in the key drive note buffer 12c and the time obtained by adding the lookahead delay time T2 to the current time is less than the second note-off advance time T6 (S100). In the processing of S100, if the time difference ΔT is less than the second note-off advance time T6 (S100: Yes), the key drive timing of the note-off stored in the key drive note buffer 12c is advanced by the second note-off advance time T6 (S101), and the processing of S28 may be performed after that.

In the processing of S25, if there is a key drive note of note-on with the same note number as that acquired in the processing of S6 in the key drive note buffer 12c (S25: Yes), it is confirmed whether the time difference ΔT between the key drive timing of the note-on stored in the key drive note buffer 12c and the time obtained by adding the lookahead delay time T2 to the current time is less than the note-on advance time T7 (S102). In the processing of S102, if the time difference ΔT is less than the note-on advance time T7 (S102: Yes), the key drive timing of the note-on stored in the key drive note buffer 12c is advanced by the note-on advance time T7 (S103), and the processing of S28 may be performed after that.

The advancement of the previous note-off and the delay of the subsequent note-off by the processing of S21 to S24 of FIG. 7 of the above embodiment may be combined with only the advancement of the previous note-on by the processing of S25 to S103 of FIG. 10 of the modification, or only the advancement of the previous note-off by the processing of S21 to S101 of FIG. 10 of the modification may be combined with only the delay of the subsequent note-off in S25 to S27 of the above embodiment.

In the above embodiment, the time for changing the key drive timing, such as the lookahead delay time T2, the note-off advance time T3, the note-on delay time T4, and the note-off delay time T5, is set in milliseconds. However, the disclosure is not limited thereto. The lookahead delay time T2 or the like may be set based on a musically meaningful time, for example, a time length of an eighth note or a sixteenth note set in the MIDI data MD, or a time length such as the lookahead delay time T2 may be set according to a tempo speed set in the MIDI data MD. In this way, by setting the lookahead delay time T2 or the like based on a musically meaningful time, the automatic operation the key 2a can be made to relatively closely match the output musical tone.

In the above embodiment, the output of a musical tone and the automatic operation the key 2a are performed based on the MIDI data MD stored in the target MIDI data 12a. However, the disclosure is not limited thereto, and the output of a musical tone and the automatic operation of the key 2a may be performed according to separate MIDI data MD. In this case, the MIDI data MD obtained by performing advancement or delay of a key drive timing corresponding to the key drive note addition processing of FIG. 7 and FIG. 10 in advance on the MIDI data MD used for output of a musical tone may be used as the MIDI data MD for automatic operation of the key 2a.

In the above embodiment, it is configured to acquire the MIDI data MD from the MIDI data 11b in the processing of S3 of FIG. 6. However, the disclosure is not limited thereto. For example, the electronic piano 1 may be provided with a communication device that communicates with an external device, and the MIDI data MD may be acquired from another device or the Internet via the communication device. In this case, the musical tone output processing and the automatic operation (driving) processing of the key 2a corresponding to performance information may be performed after all the MIDI data MD input from another device or the Internet have been read, or the output of musical tones and the automatic operation processing of the key 2a corresponding to performance information may be performed while the MIDI data MD input from another device or the Internet is received in real time.

In the above embodiment, the electronic piano 1 is illustrated as an example of the electronic musical instrument. However, the disclosure is not limited thereto, and may be applied to other electronic musical instruments such as a synthesizer or an electronic wind instrument. The control program 11a may be executed by an information processing device such as a personal computer or a portable terminal. In this case, the keyboard 2 may be connected to the information processing device such as a personal computer.

In the above embodiment, the MIDI data MD is illustrated as an example of the music data. However, the disclosure is not limited thereto. Other music-related data other than that of the MIDI standard may be used as the music data.

What is claimed is:

1. An electronic musical instrument, comprising:
a keyboard, comprising a key that allows automatic operation;
a performance information acquisition part, acquiring performance information containing note-on or note-off and an input timing of the performance information;
a key drive timing setting part, setting a key drive timing being a timing of performing automatic operation of the key of the keyboard according to the performance information acquired by the performance information acquisition part based on the input timing of the performance information;
an advancement part, in response to a time difference between the key drive timing of previous performance information set by the key drive timing setting part and the key drive timing of subsequent performance information related to the same sound as the previous performance information being less than or equal to a predetermined timing threshold, re-setting the key drive timing of the previous performance information to an advanced timing; and
an automatic operation part, performing automatic operation of the key of the keyboard based on the performance information acquired by the performance information acquisition part at the key drive timing of the performance information.

2. The electronic musical instrument according to claim 1, wherein
the key drive timing setting part sets a timing obtained by adding a lookahead delay time longer than the timing threshold to the input timing of the performance information acquired by the performance information acquisition part as the key drive timing of the performance information.

3. The electronic musical instrument according to claim 2, further comprising:
a musical tone output part, outputting a musical tone of the performance information acquired by the performance information acquisition part at a timing based on the input timing of the performance information, wherein
the musical tone output part outputs the musical tone of the performance information acquired by the performance information acquisition part at a timing obtained by delaying the input timing of the performance information by a time obtained by adding the lookahead delay time and a key drive delay time corresponding to a time required for the automatic operation of the key of the keyboard.

4. The electronic musical instrument according to claim 2, wherein,
in response to the time difference between the key drive timing of the previous performance information set by the key drive timing setting part and the key drive timing of the subsequent performance information related to the same sound as the previous performance information being less than or equal to the timing threshold, the advancement part re-sets the key drive timing of the previous performance information to a timing advanced by a first time; and
the first time is shorter than the lookahead delay time.

5. The electronic musical instrument according to claim 3, wherein,
in response to the time difference between the key drive timing of the previous performance information set by the key drive timing setting part and the key drive timing of the subsequent performance information related to the same sound as the previous performance information being less than or equal to the timing threshold, the advancement part re-sets the key drive timing of the previous performance information to a timing advanced by a first time; and
the first time is shorter than the lookahead delay time.

6. The electronic musical instrument according to claim 4, wherein
the previous performance information is note-off;
the subsequent performance information is note-on; and
the first time is further set less than or equal to a time required for the key of the keyboard to change from a completely depressed state to a completely released state by automatic operation.

7. The electronic musical instrument according to claim 1, further comprising:
a delay part, in response to the time difference between the key drive timing of the previous performance information set by the key drive timing setting part and the key drive timing of the subsequent performance information related to the same sound as the previous performance information being less than or equal to the timing threshold, re-setting the key drive timing of the subsequent performance information to a further delayed timing.

8. The electronic musical instrument according to claim 7, wherein
the key drive timing setting part sets a timing obtained by adding a lookahead delay time longer than the timing threshold to the input timing of the performance information acquired by the performance information acquisition part as the key drive timing of the performance information;
in response to the time difference between the key drive timing of the previous performance information set by the key drive timing setting part and the key drive timing of the subsequent performance information related to the same sound as the previous performance information being less than or equal to the timing threshold, the advancement part re-sets the key drive timing of the previous performance information to a timing advanced by a second time;
in response to the time difference between the key drive timing of the previous performance information set by the key drive timing setting part and the key drive timing of the subsequent performance information related to the same sound as the previous performance information being less than or equal to the timing threshold, the delay part re-sets the key drive timing of the subsequent performance information to a timing further delayed by a third time; and
a time obtained by adding the second time and the third time is shorter than the lookahead delay time.

9. The electronic musical instrument according to claim 8, wherein
the time obtained by adding the second time and the third time is further set less than or equal to a time actually required for the key of the keyboard to change from a completely depressed state to a completely released state by automatic operation.

10. An automatic operation method, executed by an electronic musical instrument comprising a keyboard comprising a key that allows automatic operation, the automatic operation method comprising:
acquiring performance information containing note-on or note-off and an input timing of the performance information;
setting a key drive timing being a timing of performing automatic operation of the key of the keyboard according to the acquired performance information based on the input timing of the performance information;
in response to a time difference between the set key drive timing of previous performance information and the set key drive timing of subsequent performance information related to the same sound as the previous performance information being less than or equal to a predetermined timing threshold, re-setting the key drive timing of the previous performance information to an advanced timing; and
performing automatic operation of the key of the keyboard based on the acquired performance information at the key drive timing of the performance information.

11. The automatic operation method according to claim 10, further comprising:
setting a timing obtained by adding a lookahead delay time longer than the timing threshold to the input timing of the acquired performance information as the key drive timing of the performance information.

12. The automatic operation method according to claim 11, further comprising:
outputting a musical tone of the acquired performance information at a timing based on the input timing of the performance information, wherein
the musical tone of the acquired performance information is output at a timing obtained by delaying the input timing of the performance information by a time obtained by adding the lookahead delay time and a key drive delay time corresponding to a time required for the automatic operation of the key of the keyboard.

13. The automatic operation method according to claim 11, further comprising:
in response to the time difference between the set key drive timing of the previous performance information and the set key drive timing of the subsequent performance information related to the same sound as the previous performance information being less than or equal to the timing threshold, re-setting the key drive timing of the previous performance information to a timing advanced by a first time, wherein
the first time is shorter than the lookahead delay time.

14. The automatic operation method according to claim 13, wherein
the previous performance information is note-off;
the subsequent performance information is note-on; and
the first time is further set less than or equal to a time required for the key of the keyboard to change from a completely depressed state to a completely released state by automatic operation.

15. The automatic operation method according to claim 10, further comprising:
in response to the time difference between the set key drive timing of the previous performance information and the set key drive timing of the subsequent performance information related to the same sound as the previous performance information being less than or equal to the timing threshold, re-setting the key drive timing of the subsequent performance information to a further delayed timing.

16. The automatic operation method according to claim 15, further comprising:
setting a timing obtained by adding a lookahead delay time longer than the timing threshold to the input timing of the acquired performance information as the key drive timing of the performance information;
in response to the time difference between the set key drive timing of the previous performance information and the set key drive timing of the subsequent performance information related to the same sound as the previous performance information being less than or equal to the timing threshold, re-setting the key drive timing of the previous performance information to a timing advanced by a second time; and
in response to the time difference between the set key drive timing of the previous performance information and the set key drive timing of the subsequent performance information related to the same sound as the previous performance information being less than or equal to the timing threshold, re-setting the key drive timing of the subsequent performance information to a timing further delayed by a third time, wherein
a time obtained by adding the second time and the third time is shorter than the lookahead delay time.

17. The automatic operation method according to claim 16, wherein
the time obtained by adding the second time and the third time is further set less than or equal to a time actually required for the key of the keyboard to change from a completely depressed state to a completely released state by automatic operation.

18. A non-transitory computer readable medium, storing an automatic operation program for causing a computer provided with a keyboard including a key that allows automatic operation to execute automatic operation processing of the key of the keyboard,
wherein the automatic operation program causes the computer to:
acquire performance information containing note-on or note-off and an input timing of the performance information;
set a key drive timing being a timing of performing automatic operation of the key of the keyboard according to the acquired performance information based on the input timing of the performance information;
in response to a time difference between the set key drive timing of previous performance information and the set key drive timing of subsequent performance information related to the same sound as the previous performance information being less than or equal to a predetermined timing threshold, re-set the key drive timing of the previous performance information to an advanced timing; and
perform automatic operation of the key of the keyboard based on the acquired performance information at the key drive timing of the performance information.
